(19) United States
(12) Patent Application Publication
(10) Pub. No.: US 2003/0236879 A1
(43) Pub. Date: Dec. 25, 2003

(54) Server, server program storage medium, and site serving method

(75) Inventors: Keisuke Moritani, Inagi (JP); Takeshi Kumazawa, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/322,678

(22) Filed: Dec. 19, 2002

(30) Foreign Application Priority Data
Jun. 19, 2002 (JP) 2002-178591

(51) Int. Cl. G06F 15/173

(52) U.S. Cl. 709/224; 345/745; 709/246

(57) ABSTRACT

A server comprises: a user DB 160 storing a plurality of users accessing said site together with user attributes associated with the users; a ranking generation section 130 taking statistics of information presented by said site on a group consisting of users wherein the user attributes are common, of the plurality of users stored in said user DB 160; and an information customizing section customizing information presented for the user by said site when received an access by the user in accordance with statistics obtained by said ranking generation section 130 for a group in which same user attribute as the user attributes of the users is a common user attribute.

### BACKGROUND OF THE INVENTION

1. Field of the Invention

The present invention relates to a server serving as at least part of a site for presenting information upon receipt of an access through a communication network, a server program storage medium storing a server program which causes a computer as the server, when the server program is executed in the computer, and site serving method for serving as at least part of a site for presenting information upon receipt of an access through a communication network.

2. Description of the Related Art

Hitherto, there is known a site for presenting information such as a home page, upon receipt of an access through a communication network, in the Internet. One or a plurality of computers (a server) manages such Internet.

There are various types of sites in the conventional sites.

A first type of site is the most popular site in which contents of pages constituting the site are common to all of the users. In such a site, there are many kinds of information, which are unnecessary for some users, other than contents (information) of interest for individual users. For this reason, in order to locate the contents (information) of interest for a user from the site, it is necessary to trace many links mutually connecting pages constituting the site to arrive at the contents of interest. This takes a lot of labor and time, and thus imposes a burden on a user.

A second type of site is a site capable of customizing contents of pages constituting the site for each user. The second type of site is classified into a type (A) in which pages are customized in accordance with an operation of a user oneself, and a type (B) in which there are provided contents associated with personal information (the distinction of sex and the like) of a user, and the contents associated with personal information of the user are presented in response to access of the user.

According to the above-mentioned type (A), a user's operation for customizing pages and the like is troublesome. And according to the above-mentioned type (B), there are presented contents associated with personal information in judgement of an operator of the site. Thus, the presented information is not always contents of interest of the user.

A third type of site is a site wherein pages and contents, which users quite often visit, are determined for each user in accordance with an access log representative of a history in which users accessed pages and links in the site, and when an access from a user to the site is generated, pages and contents, which the user quite often visit, are put up on the top page.

According to the third type of site, the contents based on the access log of the user oneself is presented, and thus the contents suited the user's taste is presented. However, even if the contents suited the user's taste is concerned, in the event that the user does not know the presence of the contents and thus no access is made, and in the event that the user is apt to forget the place of the contents, so that frequency of the access is lowered, the contents are left out from a candidate of the contents to be displayed on the top page. As a result, it would take a lot of operations and time to arrive at the contents concerned with the user's taste.

On any types of sites as mentioned above, it is a subject that contents suited the user's taste are presented and the user's burden is reduced.

For such a subject, Japanese Patent Publication TokuKai. 2001-265810 discloses a presenting method for specific contents such as an advertisement. According to this presenting method, an attribute of contents (advertisement) is determined in accordance with an access log of all the users (which are provided with attributes) for contents (advertisement) to be displayed within a page, and the contents (advertisement) are presented to a group of the users having the attribute. Specifically, the contents (advertisement) are presented to a user group, which is considered more suitable in presentation than other user group of a plurality of user groups. This presenting method is suitable for obtaining such an effect that advertisement efficiency is enhanced.

However, the use of this presenting method for the usual contents presenting method may involve the following problem. That is, there is associated with such a problem that even if the same contents are requested among many user groups of a plurality of user groups, the user group of the object presenting the contents is restricted. And further there is associated with such a problem that even if the contents, which would be refused in presentation by all the user groups, the contents are presented to the user group that is determined more suitable than other groups.

As other technologies associated with information presentation in the site, there are known a system for providing an access ranking of a site, which is disclosed in Japanese Patent Publication TokuKai. 2001-290728, a method in which points are applied to audiences of an advertisement to rouse the visual and auditory senses for the advertisement, which is disclosed in Japanese Patent Publication TokuKai. 2001-266248, and a system in which other site associated with a certain site is located in accordance with statistics of the user access, which is disclosed in Japanese Patent Publication TokuKai. 2001-109711.

### SUMMARY OF THE INVENTION

In view of the foregoing, it is an object of the present invention to provide a server capable of presenting contents suited the user's taste without being omitted and reducing the user's burden.

To achieve the above-mentioned object, the present invention provides a server serving as at least part of a site for presenting information upon receipt of an access through a communication network, said server comprising:

a user storage section for storing a plurality of users accessing said site together with user attributes associated with the users;

a statistics processing section for taking statistics of information presented by said site on a group consisting of users wherein the user attributes are common, of the plurality of users stored in said user storage section; and

an information customizing section for customizing information presented for the user by said site when received an access by the user in accordance with statistics obtained by said statistic processing section for a group in which same user attribute as the user attribute of the user is a common user attribute.

According to the server of the present invention, information presented for a user is customized in accordance with statistics in a group associated with the same user attribute as the user attribute of the user. Thus, there is established customizing reflecting accesses by other users belonging to the group, and as a result, it is possible to present information suited user's taste without omission. Also the burden imposed on a user is lightened, since there is no need for the user to customize information.

In the server according to the present invention as mentioned above, it is preferable that said user storage section stores the users together with a plurality of sorts of user attributes associated with the users;

said statistics processing section takes statistics as to the plurality of sorts of user attributes;

said server further comprises an attribute set up section for setting up a user attribute selected from among the plurality of sorts of user attributes by a user in association with the user; and

said information customizing section customizes information presented for the user in accordance with statistics as to the user attribute set up in association with the user by said attribute set up section.

According to the server having the attribute set up section, it is possible for a user to set up the user's taste to the site with simple operation and it is possible to readily obtain information more suited taste of the user.

In the server according to the present invention as mentioned above, it is acceptable that said site presents information consisting of a plurality of pages carrying information on a unit of page,

said information customizing section customizes information carried on the pages.

In this case, it is preferable that said pages and said information are associated with information attributes,

said information customizing section customizes information carried on said pages using information which same information attribute as the information attribute of the page is associated with.

It is inconvenient that information irrelevant to the page before customizing is presented, even if it suits the user's taste. However, customizing using information which same information attribute as the information attribute of the page is associated with make it possible to avoid such inconvenience.

In the server according to the present invention as mentioned above, it is acceptable that said site is so arranged that a plurality of pages carrying information is mutually linked, and

said information customizing section customizes a link structure of the pages.

Alternatively, it is acceptable that said site presents information consisting of a plurality of pages carrying information on a unit of page,

said information customizing section customizes a presenting order of the pages.

To achieve the above-mentioned object, the present invention provides a server program storage medium storing a server program to be executed by a computer, said server program causing said computer to be a server serving as at least part of a site for presenting information upon receipt of an access through a communication network, said server program comprising:

a statistics processing section for taking statistics of information presented by said site on a group consisting of users wherein user attributes are common, of a plurality of users stored in a user storage section for storing a plurality of users accessing said site together with user attributes associated with the users; and

an information customizing section for customizing information presented for the user by said site when received an access by the user in accordance with statistics obtained by said statistic processing section for a group in which same user attribute as the user attribute of the user is a common user attribute.

With respect to the server program storage medium according to the present invention, for the purpose of avoiding redundancy, there is shown only the basic form as set forth above. It is noted that the server program storage medium according to the present invention includes not only the basic form of server program storage medium as set forth above, but also various forms of server program storage medium corresponding to the various forms of server as mentioned above.

In the server of the present invention and the server program storage medium, as names of the structural elements, the same names such as the statistics processing section and the information customizing section are applied therebetween. However, in case of the server program storage medium, the structural elements denote the software. On the other hand, in case of the server, the structural elements include the hardware.

As to the structural elements such as the statistics processing section constituting the server program storage medium, it is acceptable that the function of one structural element is implemented by one program component, the function of one structural element is implemented by a plurality of program components, or alternatively the function of a plurality of structural elements is implemented by one program component. Further, it is acceptable that those structural elements implement their functions by oneself, or alternatively those structural elements implement their functions by issuing instructs to another program incorporated into the computer or the program component.

To achieve the above-mentioned object, the present invention provides a site serving method serving as at least part of a site for presenting information upon receipt of an access through a communication network, said site serving method comprising:

a statistics processing step of taking statistics of information presented by said site on a group consisting of users wherein user attributes are common, of a plurality of users stored in a user storage section for storing a plurality of users accessing said site together with user attributes associated with the users; and

an information customizing step of customizing information presented for the user by said site when received an access by the user in accordance with statistics obtained by said statistics processing section for a group in which same user attribute as the user attribute of the user is a common user attribute.

### BRIEF DESCRIPTION OF THE DRAWINGS

FIG. 1 is a view showing an embodiment of a server according to the present invention.

FIG. 2 is a hardware construction view of the server shown in FIG. 1.

FIG. 3 is a view showing an embodiment of a server program of the present invention.

FIG. 4 is a functional block diagram of an embodiment of a server of the present invention.

FIG. 5 is an explanatory view useful for understanding operations of a server.

FIG. 6 is a view showing user attributes and the like of user A.

FIG. 7 is a view showing an example of the top page presented for user A.

FIG. 8 is a view showing user attributes and the like of user B.

FIG. 9 is a view showing an example of the top page presented for user B.

### DETAILED DESCRIPTION OF PREFERRED EMBODIMENTS

Embodiments of the present invention will be described with reference to the accompanying drawings.

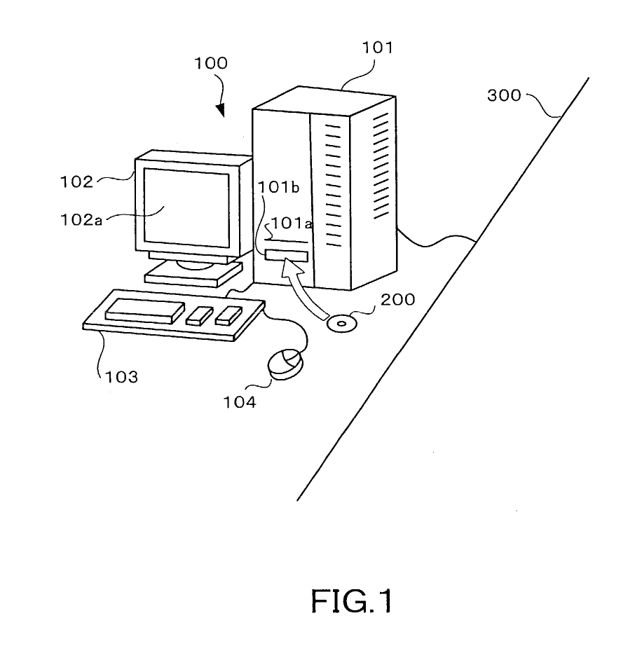

FIG. 1 is a view showing an embodiment of a server according to the present invention.

A server 100 (Web server) is connected to an Internet and the like via a communication network 300 to provide a site (Web site) on a net. According to the present embodiment, the server 100 is in charge of a site in its entirety. The site, which is provided by the server 100, is constituted in such a manner that a plurality of pages (Web pages) carrying information is mutually linked. This site presents the pages carrying information to an access through the communication network 300 so that the information is presented. The user, who accessed the site, may read the presented information through display on one's own computer by browser (read software). Incidentally, a data communication between the server 100 and the browser is performed through, for example, HTTP (Hyper Text Transfer Protocol) which is well known.

The server 100 comprise: a main frame 101 incorporating therein a CPU (Central Processing Unit), a RAM (Random Access Memory), and a hard disk; a CRT display unit 102 for displaying images and strings of characters on display screen 102a in accordance with instructions from the main frame 101; a keyboard 103 for inputting user's instructions and character information to the computer system; and a mouse 104 for inputting orders associated with icons or the like displayed on positions on the display screen 102a when the positions are designated.

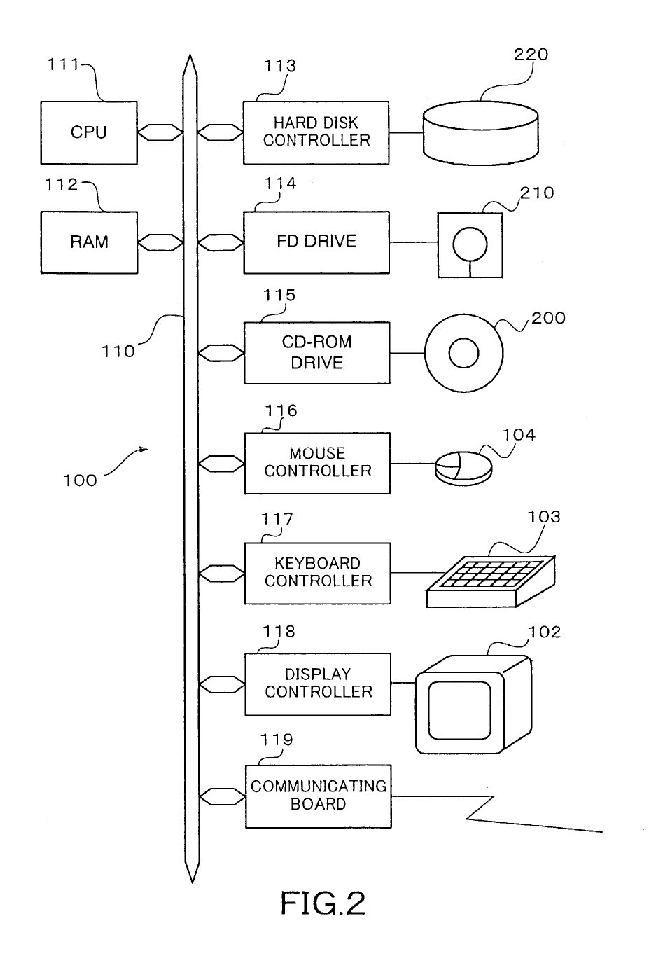

The main frame 101 of the server 100 comprises, on the outside appearance, a flexible disk (not illustrated in FIG. 1, cf. FIG. 2), a flexible disk mounting slot 101a onto which CD-ROM 200 is loaded, and a CD-ROM mounting slot 101a. Inside the main frame 101, there are incorporated a flexible disk drive 114 (not illustrated in FIG. 1, cf. FIG. 2) for driving the flexible disk loaded through the flexible disk mounting slot 101a, and a CD-ROM drive 115 (not illustrated in FIG. 1, cf. FIG. 2) for driving the CD-ROM 200 loaded through the CD-ROM mounting slot 101a.

The CD-ROM 200 stores therein an embodiment of a server program of the present invention. When the CD-ROM 200 is loaded from the CD-ROM mounting slot 101ainto the main frame 101, the serve program stored in the CD-ROM 200 is installed in the hard disk of the computer system by the CD-ROM drive 115. When the serve program installed in the hard disk of the computer system is started, the computer system operates as the embodiment of the server of the present invention. Incidentally, the storage medium storing the server program of the present invention is not restricted to the above-mentioned CD-ROM, and it is acceptable that the storage medium storing the server program of the present invention is a hard disk, a flexible disk, or a magneto-optical disk (MO).

FIG. 2 is a hardware construction view of the server shown in FIG. 1.

The hardware construction view of the server shows a central processing unit (CPU) 111, a RAM 112, a hard disk controller 113, a flexible disk drive 114, a CD-ROM drive 115, a mouse controller 116, a keyboard controller 117, a display controller 118, and a communicating board 119. Those are connected to one another through a bus 110.

The flexible disk drive 114 and the CD-ROM drive 115 access, as described referring to FIG. 1, the flexible disk 210 and the CD-ROM 200, which are loaded through the flexible disk mounting slot 101a and the CD-ROM mounting slot 101a, respectively.

The communicating board 119 is connected to the communication line 300.

FIG. 2 further shows a hard disk 220 to be accessed by the hard disk controller 113, a mouse 104 to be controlled by the mouse controller 116, a keyboard 103 to be controlled by the keyboard controller 117, and a CRT display 102 to be controlled by the display controller 118.

As mentioned above, the CD-ROM 200 stores a server program, and the server program is read from the CD-ROM 200 by the CD-ROM drive 115 and is stored via the bus 110 in the hard disk 220 by the hard disk controller 113. Actually, the server program in the hard disk 220 is loaded onto the RAM 112 and is executed by the CPU 111.

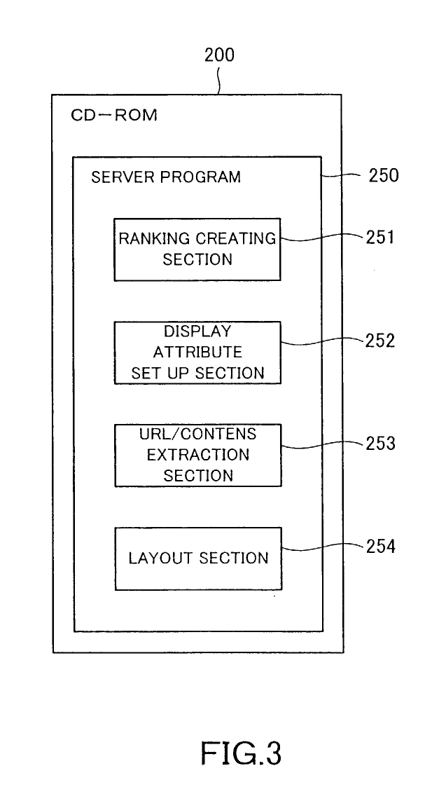

FIG. 3 is a view showing an embodiment of a server program of the present invention. As mentioned above, a server program 250 is stored in the CD-ROM 200.

The server program 250 causes the server 100 shown in FIGS. 1 and 2 to operate so as to be in charge of the above-mentioned site. The server program 250 comprises a ranking creating section 251, a display attribute set up section 252, a URL/contents extraction section 253, and a layout section 254.

Here, there will be explained outlines of the respective elements of the server program 250, while the details of the elements of the server program 250 will be described later.

The ranking creating section 251 is an example of a statistics processing section referred to in the present invention, and serves to create a ranking of the page accessed by a user by way of an example of statistics.

The display attribute set up section 252 is an example of an attribute sort set up section referred to in the present invention, and serves to set up a user attribute selected by a user, of user attributes associated with users as will be described later.

The URL/contents extraction section 253 and the layout section 254 constitute an example of an information customizing section referred to in the present invention. The URL/contents extraction section 253 has a function of extracting URL and contents in accordance with the ranking created in the ranking creating section 251. The layout section 254 has a function of making a layout for a page using the contents extracted by the URL/contents extraction section 253.

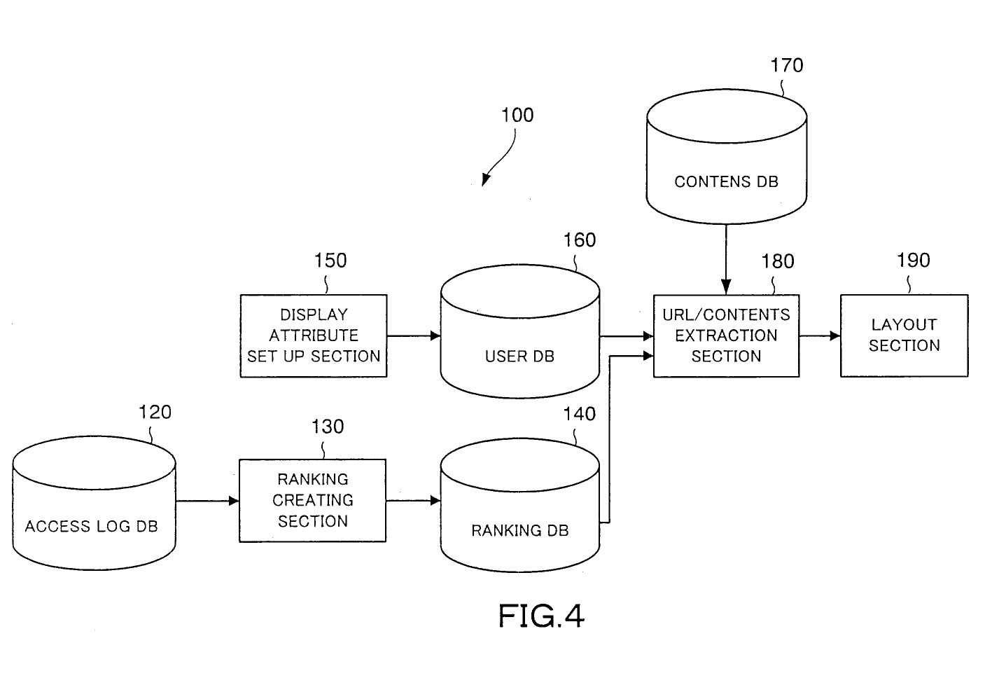

FIG. 4 is a functional block diagram of an embodiment of a server of the present invention.

A functional structure shown in the functional block diagram of FIG. 4 is constructed when the server program 250 shown in FIG. 3 is installed in the server 100 shown in FIGS. 1 and 2 and is executed.

As shown in the functional block diagram, the server 100 comprises: an access log DB (data base) 120; a ranking creating section 130; a ranking DB 140; a display attribute set up section 150; a user DB 160; a contents DB 170; a URL/contents extraction section 180; and a layout section 190. Of those elements, the ranking creating section 130, the display attribute set up section 150, the URL/contents extraction section 180, and the layout section 190 correspond to the ranking creating section 251, the display attribute set up section 252, the URL/contents extraction section 253, and the layout section 254, respectively, which constitute the server program shown in FIG. 3. The respective elements shown in FIG. 4 are constructed in combination of the hardware of the server 100 shown in FIGS. 1 and 2 and OS and application program executed in the server 100. While the respective elements of the server program shown in FIG. 3 are constructed by only the application program. Hereinafter, there will be explained detailed functions of the respective elements of the server 100 shown in FIG. 4 as well as functions of the respective elements of the server program 250 shown in FIG. 3.

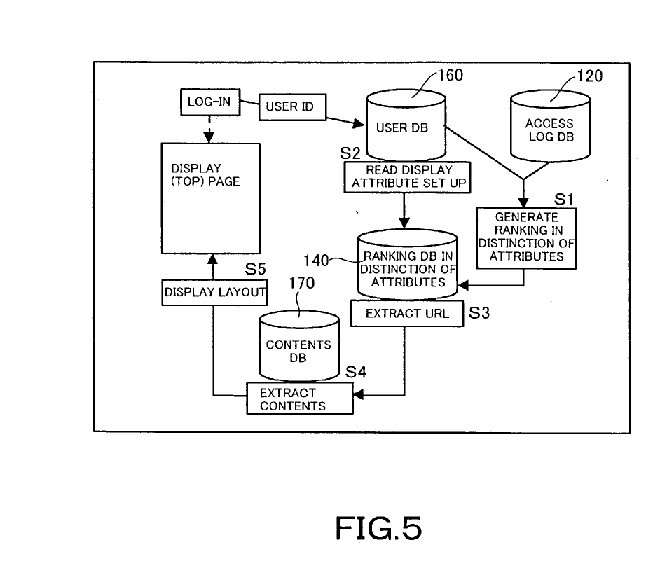

FIG. 5 is an explanatory view useful for understanding operations of the server 100. Hereinafter, there will be explained the operations referring to the server 100.

The server 100 has a function (not illustrated) of recording an access of a user to a site presented by the server 100. This function makes it possible to store a so-called access log into the access log DB 120 on all accesses for all pages of the site. When the access to the site is made, a user ID identifying a user is presented. The access log stored in the access log DB 120 includes a user ID, the date and time, URL (Uniform Resource Locator), and the number of cumulative accesses of the page.

A user, who accesses the site presented by the server 100, is the user registered in the user DB 160 beforehand. The user DB 160 registers user ID and a plurality of types of user attributes for each user. As the user attributes, there are registered a type name representative a type of a computer of a user, an OS (Operating System) incorporated into the computer, types of peripheral equipment of the computer, user's age, sex, and the distinction of a private person/a juristic person/SOHO. The user DB 160 further registers a type of the user attribute selected by the user from among the plurality of types of user attributes in form of a display attribute which is a standard of customizing. This display attribute is set up utilizing the display attribute set up section 150 via the communication network so that a user issues instruction to a site a field of information suited one's taste. This display attribute may be set up in accordance with a simple operation that the user designates a number to distinguish the plurality of types of user attributes from one another. In the event that the user omits the operation for setting up the display attribute, there is set up a display attribute that is prepared at the operator side of the site in form of default.

The ranking creating section 130 creates at any time an access ranking by user attribute in accordance with information stored in the access log DB 120 and the user DB 160 (step S1). In the detailed description of the step S1, first, a user ID is obtained from the user ID stored in the user DB 160 through dividing into groups in which the user attribute is common. Now, paying attention to the user attribute, for example, “the distinction of sex”, the user ID, which belongs to both group of “male” and group of “female”, is obtained. Likely, paying attention to another type of user attribute, a result of the grouping on a similar fashion is obtained. Next, on each of the groups of the user ID obtained thus, the whole records of the access, in which the user ID belonging to the group is used, is extracted from the access log DB 120. And from the record thus extracted, URL of the accessed page and the number of accesses to the page are totaled up. The number of accesses represents frequency in utility of information provided by the page. Thus, when the number of accesses is totaled up, there is created a list in which the URLs are sorted in order of the large number of accesses, and the URLs are associated with the user attributes common to the groups of the total up object and are stored in the ranking DB 140 in form of the access ranking by the user attribute.

When the access ranking by the user attribute as mentioned above is obtained, there is obtained statistics representative of the user's taste in the groups of the user in which the user attributes are common. While the access by individual users may involve such a situation that the information suited one's taste is missed, it is expected that when the group is viewed as a whole, an access is made to information suited the user's taste without loss and thus the user's taste is surely reflected to the obtained statistics.

Thus, in a state that the access ranking by the user attribute is stored in the ranking DB 140, when a user accesses to the site using the user ID registered, the display attribute associated with the user ID is read from the user DB 160 (step S2). As the access by a user to the site, there are considered the access designated the page in the site and log-in to the site. The log-in to the site has the same meaning as a so-called top page of the site being requested. Hereinafter, there will be explained the operation at the time of the log-in.

When a user performs the log-in to the site so that a display attribute is read, the URL/contents extraction section 180 extracts from the ranking DB 140 the access ranking of the user attribute associated with the display attribute of the user attributes of the user so that URL and the ranking are obtained (step S3).

The URL/contents extraction section 180 further extracts from the contents DB 170 the contents to be described at the page (here the top page) to be presented for the user in a manner as set forth below (step S4).

The contents DB 170 stores URLs of pages in the site, indexes linked to the pages, and information attributes applied to the pages. The index of pages consists of a string of characters and an image. When the Browser of a user displays the index and the user clicks the index, the page linked to the index is called and displayed. The information attribute is used for indicating the sort of information to be presented by the page. According to the present embodiment, by way of example, the information attribute identifying one of the sorts of the above-mentioned user attribute is applied to the respective pages. Of the indexes stored in the contents DB 170, the index, which is associated with the same URL as the URL appearing on the above-mentioned access ranking, is retrieved. Further, there is performed a matching between information attribute associated with the index founded through the retrieval and information attribute of the page (here the top page) to be presented for a user, so that the index approved in matching is extracted.

When the URL/contents extraction section 180 extracted the index in this manner, the layout section 190 creates a layout in which the indexes are arranged in order of the access ranking (step S5), so that the top page of the layout is presented for the user. As a method of creating the layout, here, there is adopted a creating method in which there is prepared a creating script wherein a CSV (Common Space Value) format of list, in which the extracted indexes are arranged in order of the access ranking, is read and rewritten into the HTML format of list, and the creating script is called in the top page.

On the top page thus displayed, there is first carried the index of a page that is high in utilizing frequency in a group expected that it has the same taste as the user's taste. That is, according to the present embodiment, information appearing on the top page is customized. And the indexes are linked over the pages of the site. Thus, when the indexes appearing on the top page are changed, the link structure is also changed. Therefore, according to the present embodiment, customizing of the link structure is also performed. Further, when a user utilizes the top page in which the indexes are arranged and displayed in this manner, it is expected that the user first accesses the page linked to the index first carried. Thus, according to the present embodiment, customizing of the presenting order of the page is also performed.

Hereinafter, there will be explained the function of the server further raising embodiments of user attributes and the top page. Here it is assumed that users are two users such as user A and user B.

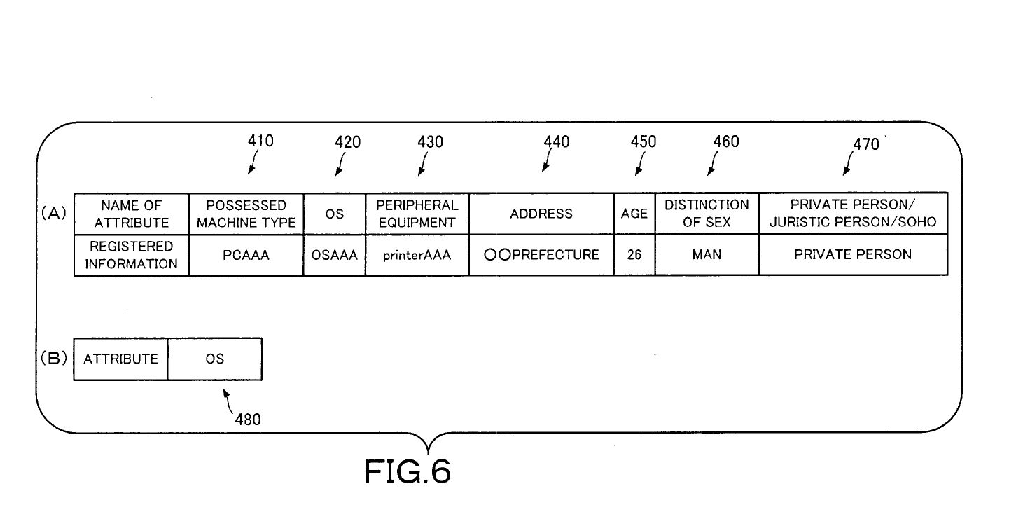

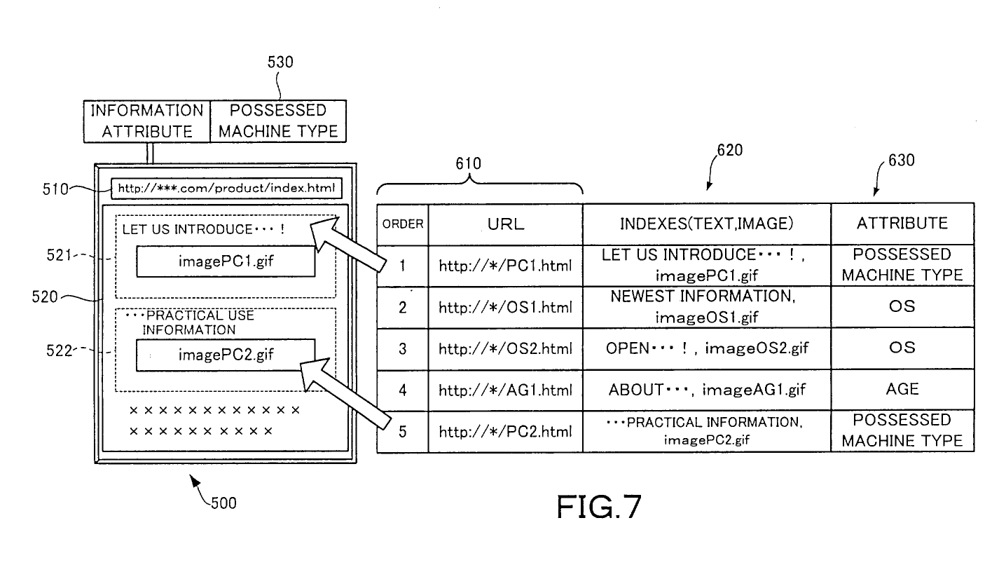

FIG. 6 is a view showing user attributes and the like of user A. FIG. 7 is a view showing an example of the top page presented for user A.

A part (A) of FIG. 6 shows user attributes registered on the user A. As a user attribute 410 in sort named “possessed machine type”, “PCAAA” is registered. Likely, as a user attribute 420 in sort named “OS”, “OSAAA”; as a user attribute 430 in sort named “peripheral equipment”, “printerAAA”; as a user attribute 440 in sort named “address”, “OO prefecture”; as a user attribute 450 in sort named “age”, “26”; as a user attribute 460 in sort named “distinction of sex”, “man”; and as a user attribute 470 in sort named “distinction of a private person/a juristic person/SOHO”, “private person”.

A part (B) of FIG. 6 shows “OS” as a display attribute 480 set up by the user A. Since the user attribute 420 in sort named “OS” shown in the part (A) of FIG. 6 registers therein “OSAAA”, information to be presented for the user A is customized in accordance with the access ranking in a group of the users having the user attribute “OSAAA” on a common basis.

Here there will be explained advantageous points when a user is set up as the display attribute for each sort of the user attribute.

In the event that the “possessed machine type” is set up as the display attribute, it is possible to obtain information optimized for the machine type of the computer, which the user possesses. For example, it is possible to obtain information related to renewal of the driver, information of the support service such as a repair state, and campaign information restricted in object machine type.

In the event that “OS” is set up as the display attribute, it is possible to obtain information optimized for OS used in the computer of the user. For example, it is possible to obtain information related to the down load of the driver.

In the event that the “peripheral equipment” is set up as the display attribute, it is possible to obtain information optimized for the peripheral equipment, which the user possesses. For example, it is possible to obtain a confirmation result as to whether a device is operative under the specific environment, and driver information.

In the event that the “address” is set up as the display attribute, it is possible to obtain information as to an especial matter for the area in which the user lives. For example, it is possible to obtain information as to for example, weather, news and support window.

In the event that the “age” is set up as the display attribute, it is possible to obtain information as to an especial matter for age and generation of the user. For example, it is possible to obtain information as to service for a person of advanced age.

In the event that the “distinction of sex” is set up as the display attribute, it is possible to obtain information as to an especial matter for man and woman. For example, it is possible to obtain information as to woman restriction service.

In the event that the “distinction of a private person/a juristic person/SOHO” is set up as the display attribute, it is possible to obtain information as to an especial matter for a private person, a juristic person and SOHO. For example, it is possible to obtain information as to news and campaign.

Now turning back to the explanation of customizing of information for the user A.

FIG. 7 shows an access ranking 610 in a group of users having user attribute named “OSAAA” on a common basis, and a top page 500 which is customized in accordance with the access ranking 610.

According to the access ranking 610 shown in FIG. 7, it is indicated that a page represented by URL “http://*/PC1.html” stands first in access number, and a page represented by URL “http://*/PC2.html” stands fifth in access number. As mentioned above, the URLs appearing on the access ranking 610 are used to extract the index from the contents DB 170. FIG. 7 shows extracted indexes 620 and information attributes 630 applied to pages linked to the extracted indexes 620 in association with the URLs appearing on the access ranking 610.

A top page 500 is designated through a predetermined URL 510. When the top page 500 is presented for a user, the browser of the user displays a screen 520. The top page 500 is provided with “possessed machine type” as an information attribute 530. Of the indexes 620 extracted from the contents DB 170, indexes 521 and 522, in which the associated information attributes are “possessed machine type”, are extracted and arranged on the screen 520.

In this manner, regarding the user A, there is presented the top page 500 in which the index 521 linked to the page represented by URL “http://*/PC1.html”, and the index 522 linked to the page represented by URL “http://*/PC2.html”.

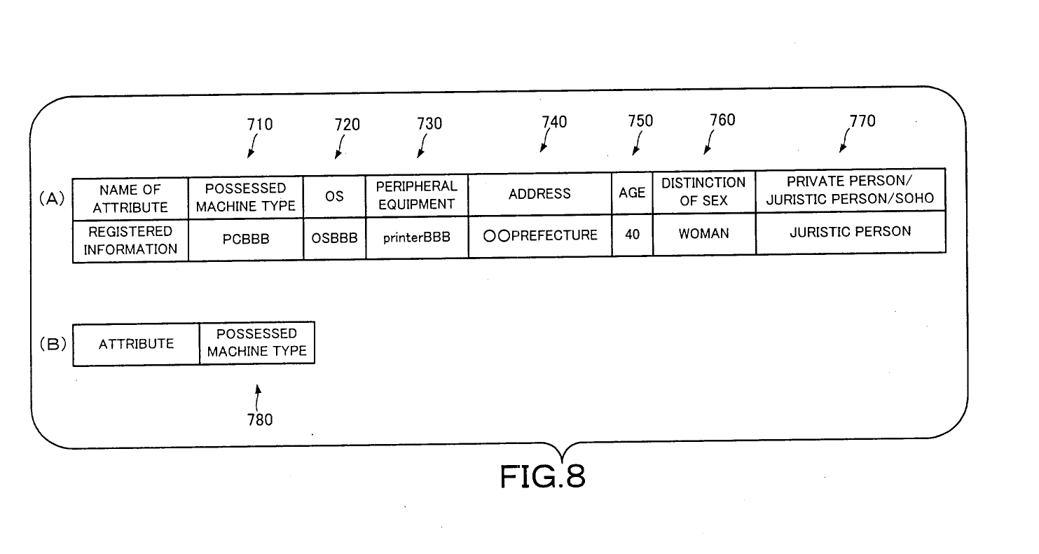

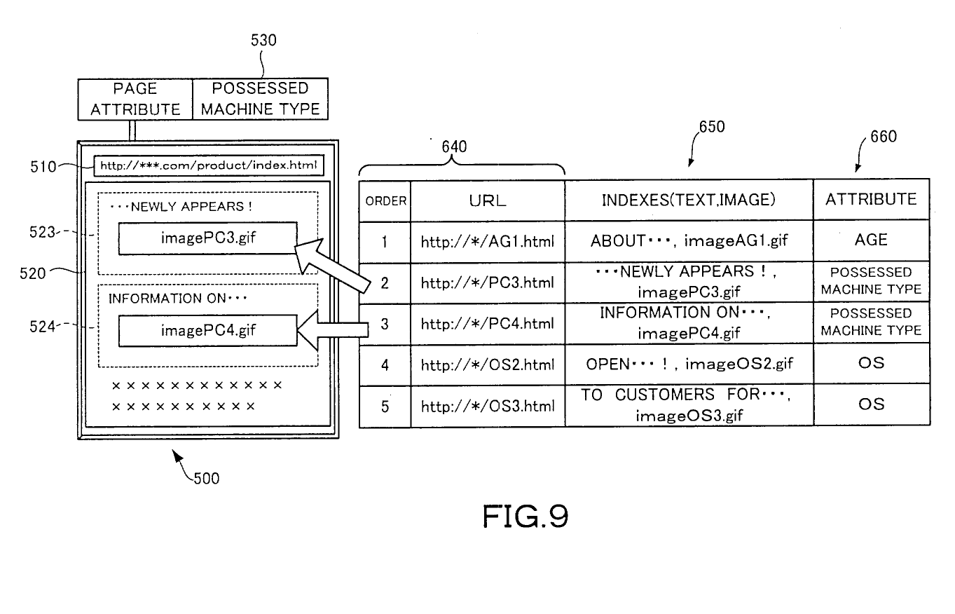

FIG. 8 is a view showing user attributes and the like of user B. FIG. 9 is a view showing an example of the top page presented for user B.

A part (A) of FIG. 8 shows user attributes registered on the user B. As a user attribute 710 in sort named “possessed machine type”, “PCBBB” is registered. Likely, as a user attribute 720 in sort named “OS”, “OSBBB”; as a user attribute 730 in sort named “peripheral equipment”, “printerBBB”; as a user attribute 740 in sort named “address”, “XX prefecture”; as a user attribute 750 in sort named “age”, “40”; as a user attribute 760 in sort named “distinction of sex”, “woman”; and as a user attribute 770 in sort named “distinction of a private person/a juristic person/SOHO”, “juristic person”.

A part (B) of FIG. 8 shows “possessed machine type” as a display attribute 780 set up by the user B. Since the user attribute 710 in sort named “possessed machine type” shown in the part (A) of FIG. 8 registers therein “PCBBB”, information to be presented for the user B is customized in accordance with the access ranking in a group of the users having the user attribute “PCBBB” on a common basis.

FIG. 9 shows an access ranking 640 in a group of users having user attribute named “PCBBB” on a common basis, and a top page 500 which is customized in accordance with the access ranking 640.

According to the access ranking 640 shown in FIG. 9, it is indicated that a page represented by URL “http://*/AG1.html” stands first in access number, and a page represented by URL “http://*/OS3.html” stands fifth in access number. FIG. 9 shows indexes 650 extracted using the URLs appearing on the access ranking 640 and information attributes 660 applied to pages linked to the extracted indexes 650 in association with the URLs appearing on the access ranking 640.

The URL 510 and the information attribute 530 are completely same as those shown in FIG. 7. However, in the event that the top page 500 is presented for the user B, the customizing is performed in accordance with the index 650 extracted from the contents DB 170. Thus, there is presented the top page 500 in which the index 523 linked to the page represented by URL “http://*/PC3.html”, and the index 524 linked to the page represented by URL “http: //*/PC4.html”.

In this manner, according to the present embodiment, the indexes are customized in accordance with a tendency of accesses of a group to which a user belongs. Thus, information suited the user's taste is presented without omission. Further, in order that the user have the thus customized information presentation, it is sufficient for the user to simply set up the display attribute. Thus the burden imposed on the user is lightened.

Incidentally, according to the above explanation, there is raised, by way of example, a server is in charge of a site in its entirety. However, it is acceptable that the server according to the present invention is in charge of a part of the site.

Further, according to the above explanation, a plurality of sorts of user attributes is registered into the user DB. However, it is acceptable that the user storage section referred to in the resent invention stores therein only one sort of user attribute.

Furthermore, according to the above explanation, there is shown an example in which a link structure between pages is customized so that a presenting order of pages is customized. However, according to the server of the present invention, it is acceptable that supposing technology of page jump, a jumping destination is customized so that a presenting order of pages is customized.

Still further, according to the above explanation, there is raised, by way of example, a site presenting information in unit of page. However, according to the server of the present invention, it is acceptable that the site referred to in the present invention has no concept of page.

Still furthermore, according to the above explanation, there is shown an example in which information attribute is applied for each page. However, according to the server of the present invention, it is acceptable that the information attribute referred to in the present invention is applied for each information constituting page.

Although the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

What is claimed is:

1. A server serving as at least part of a site for presenting information upon receipt of an access through a communication network, said server comprising:
a user storage section storing a plurality of users accessing said site together with user attributes associated with the users;
a statistics processing section taking statistics of information presented by said site on a group consisting of users wherein the user attributes are common, of the plurality of users stored in said user storage section; and
an information customizing section customizing information presented for the user by said site when received an access by the user in accordance with statistics obtained by said statistic processing section for a group in which same user attribute as the user attribute of the user is a common user attribute.

2. A server according to claim 1, wherein said user storage section stores the users together with a plurality of sorts of user attributes associated with the users;
said statistics processing section takes statistics as to the plurality of sorts of user attributes;
said server further comprises an attribute set up section setting up a user attribute selected from among the plurality of sorts of user attributes by a user in association with the user; and
said information customizing section customizes information presented for the user in accordance with statistics as to the user attribute set up in association with the user by said attribute set up section.

3. A server according to claim 1, wherein said site presents information consisting of a plurality of pages carrying information on a unit of page,
said information customizing section customizes information carried on the pages.

4. A server according claim 3, wherein said pages and said information are associated with information attributes,
said information customizing section customizes information carried on said pages using information which same information attribute as the information attribute of the page is associated with.

5. A server according to claim 1, wherein said site is so arranged that a plurality of pages carrying information is mutually linked, and
said information customizing section customizes a link structure of the pages.

6. A server according to claim 1, wherein said site presents information consisting of a plurality of pages carrying information on a unit of page,
said information customizing section customizes a presenting order of the pages.

7. A server program storage medium storing a server program to be executed by a computer, said server program causing said computer to be a server serving as at least part of a site for presenting information upon receipt of an access through a communication network, said server program comprising:
a statistics processing section for taking statistics of information presented by said site on a group consisting of users wherein user attributes are common, of a plurality of users stored in a user storage section for storing a plurality of users accessing said site together with user attributes associated with the users; and
an information customizing section for customizing information presented for the user by said site when received an access by the user in accordance with statistics obtained by said statistics processing section for a group in which same user attribute as the user attribute of the user is a common user attribute.

8. A server program storage medium according to claim 7, wherein said user storage section stores the users together with a plurality of sorts of user attributes associated with the users;
said statistics processing section takes statistics as to the plurality of sorts of user attributes;
said server further comprises an attribute set up section for setting up a user attribute selected from among the plurality of sorts of user attributes by a user in association with the user; and
said information customizing section customizes information presented for the user in accordance with statistics as to the user attribute set up in association with the user by said attribute set up section.

9. A server program storage medium according to claim 7, wherein said site presents information consisting of a plurality of pages carrying information on a unit of page,
said information customizing section customizes information carried on the pages.

10. A server program storage medium according to claim 9, according claim 3, wherein said pages and said information are associated with information attributes,
said information customizing section customizes information carried on said pages using information which same information attribute as the information attribute of the page is associated with.

11. A server program storage medium according to claim 7, wherein said site is so arranged that a plurality of pages carrying information is mutually linked, and
said information customizing section customizes a link structure of the pages.

12. A server program storage medium according to claim 7, wherein said site presents information consisting of a plurality of pages carrying information on a unit of page,
said information customizing section customizes a presenting order of the pages.

13. A site serving method for serving as at least part of a site for presenting information upon receipt of an access through a communication network, said site serving method comprising:
a statistics processing step of taking statistics of information presented by said site on a group consisting of users wherein user attributes are common, of a plurality of users stored in a user storage section for storing a plurality of users accessing said site together with user attributes associated with the users; and
an information customizing step of customizing information presented for the user by said site when received an access by the user in accordance with statistics obtained by said statistics processing section for a group in which same user attribute as the user attribute of the user is a common user attribute.
